(19) United States
(12) Patent Application Publication
(10) Pub. No.: US 2005/0094807 A1
(43) Pub. Date: May 5, 2005

(54) Accuracy array assay system and method

(76) Inventors: John Silzel, Yorba Linda, CA (US); Keith Offord, Dana Point, CA (US); Garrick Maurer, Tustin, CA (US)

Correspondence Address: SHELDON & MAK PC, 225 SOUTH LAKE AVENUE, 9TH FLOOR, PASADENA, CA, 91101, US

(21) Appl. No.: 10/701,986

(22) Filed: Nov. 4, 2003

(51) Int. Cl. H04L 9/00

(52) U.S. Cl. 380/46

(57) ABSTRACT

An array device for detection of targets has a plurality of detection zones containing different detection spots in a predetermined pattern, such as edge effects. The detection spots are randomized to reduce inaccuracies resulting from spatial effects. Preferably, no two detection zones have the same pre-determined pattern. The device can be provided with a readable code to allow a detector to determine the predetermined pattern used for the array.

### BACKGROUND

Arrays of detectors such as micro-arrays are used in a variety of diverse fields, such as pharmaceutical drug discovery, molecular biology, biochemistry, pharmacology, and medical diagnostic technology. Arrays containing a plurality of detectors, which can be the same or different, are used for detecting targets. Arrays have been used to screen for peptides or potential drugs which bind to receptors of interest; to screen samples for the presence of genetic mutations, alleic variance in a population, or a particular pathogen or strain of pathogen; to study gene expression; to determine body fluid content, such as compounds of interest in blood or urine, and other applications. Arrays can be used for both qualitative and quantitative analysis.

Information about manufacture and/or use of arrays can be found in U.S. Pat. Nos. 5,429,807, 5,981,185, 6,037,124 and 6,238,859 and U.S. patent application Ser. No. 10/128,281 filed Apr. 23, 2002 (Attorney Docket 13673) and Ser. No. 10/408,626, filed Apr. 7, 2003 (Attorney Docket 13715 (2063-181)) which are incorporated herein by reference.

There is always a need to improve the accuracy and reliability of such arrays.

### SUMMARY

The present invention is directed to a array detection device that provides such improved accuracy. The device, which is used for detection of targets, comprises an array of at least four spaced apart detection zones, each detection zone containing at least six spaced part detection spots in a predetermined pattern. The detection spots provide a detectible indication of the presence of a specific target. There are at least three different detection spots in each detection zone.

It has been discovered that in such an array, results obtained from the detection spots at the edge of the detection zone do not provide results as reliable as results from spots that are not along one of the edges. Since the practice in the prior art is to have the pattern of detection spots in all detection zones be identical, this cap cause inaccurate results for those targets whose detection spots are along the edge of the detection zone.

According to the present invention and to overcome this problem, the predetermined patterns are randomized. This can result in no detection zones having the same predetermined pattern. Preferably, the pre-determined patterns are determined with a random number generator, also referred to as pseudo-random number generator.

In another aspect of the invention, the array device can be provided with a readable code that allows a detector to determine the pattern of the detection spots in the detection zone. Although use of the readable code is particularly advantageous with an array where at least some of the detection zones have randomized patterns, the readable code can be used with an array where all of the detection zones have the same pattern. Preferably, the readable code is machine readable, such as by a bar code reader. Preferably, the code is encrypted for security purposes.

With proper randomization of the patterns, the edge effects have substantially no effect on the accuracy of the device.

To use a device according to the present invention, a sample is applied to the device so that targets in the sample cause at least some of the detection spots to provide a detectible indication. The readable code is read to determine the pre-determined patterns from the detectible indications, and from knowledge of the pre-determined patterns, it is possible to detect targets present in a sample.

### DRAWINGS

Additional features and advantages of the present invention will be better understood with reference to the following description, appended claims, and accompanying drawings where:

FIG. 1 is a schematic view of a prior art micro-array device where detection zones have the same pattern;

FIG. 2 is a schematic view of a micro-array device according to the present invention;

FIG. 3 is a flow chart showing how detection zones can be randomized according to the present invention; and

FIG. 4 shows the layout of a 96 well micro-array device according to the present invention.

### DESCRIPTION

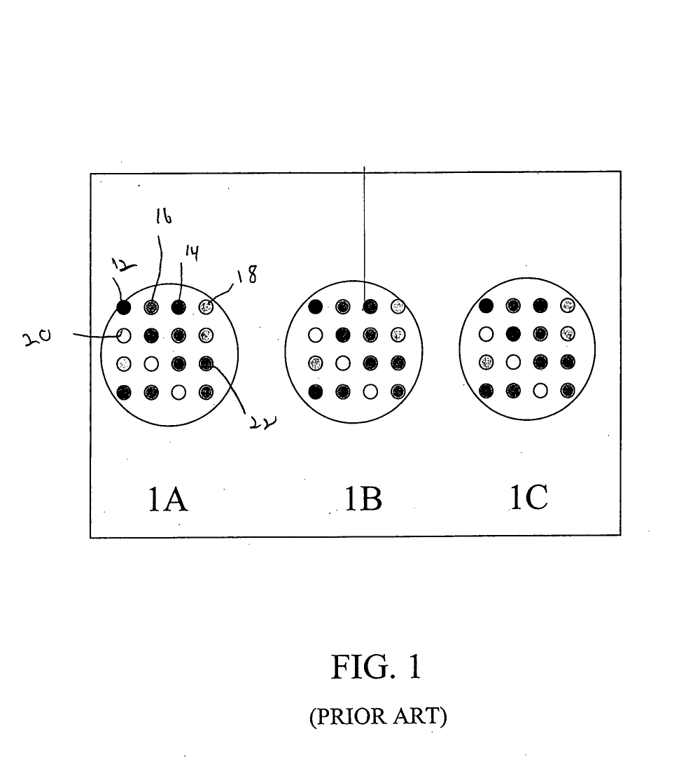

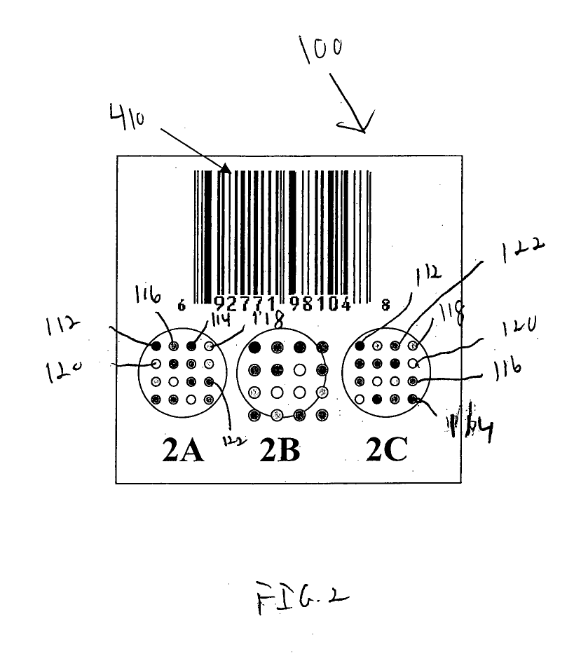

FIG. 1 shows a prior art array device 10 for detecting targets. FIG. 2 shows a similar array device 100, but improved in accordance with the present invention.

The prior art device 10 comprises three substantially identical detection zones, which can be wells, 1A, 1B and 1C. The device 100 comprises three detection zones 2A, 2B, and 2C, which are different. Each well 1 of the prior art detection device 10 contains sixteen spots, a register spot 12 and three each of five different types of detection spots 14, 16, 18, 20 and 22. In the prior art device, each of the three wells 1 has the same predetermined pattern for the detection spots.

Similarly, the improved array device 100 according to the present invention has in each of its wells 2 sixteen detection spots, one register detection spot 112 and three each of five different types of detection spots 114, 116, 118, 120, and 122.

Each of the detection spots typically contains a plurality of detectors that provide a detectible indication of a presence of a specific target. Each detection spot can contain a multitude of substantially identical detectors. For example, as stated in U.S. Pat. No. 5,925,525, the density of detectors can be in excess of 10,000 detectors per square centimeter.

In the improved device 100 according to the present invention the detection spots are in a randomized pre-determined pattern so that preferably no two detection zones have the same pattern.

As used herein, the term “target” refers to any substance whose presence, activity and/or amount is desired to be determined. Targets can be man-made or naturally-occurring substances. Also, they can be employed in their unaltered state or as aggregates with other species such as antibodies and signal generators such as fluorophores. In an exemplary version of the invention, a sample containing a target can be subject to a sandwich assay, where one portion of the resulting sandwich has a fluorophore, and another portion of the sandwich binds to an anchor (also referred to as a detector) in the detection spot. Thus, the detector in the detection zone need not bind directly to the target. Targets can be attached, covalently or noncovalently, to a binding member, either directly or via a specific binding substance. Examples of targets which can be employed in this invention include, but are not limited to, prions; receptors (on vesicles, lipids, cell membranes or a variety of other receptors); ligands, agonists or antagonists which bind to specific receptors; polyclonal antibodies, monoclonal antibodies and antisera reactive with specific antigenic determinants (such as on viruses, cells or other materials); drugs; nucleic acids or polynucleotides (including MRNA, tRNA, rRNA, oligonucleotides, DNA, viral RNA or DNA, ESTs, cDNA, PCR-amplified products derived from RNA or DNA, and mutations, variants or modifications thereof); proteins (including enzymes, such as those responsible for cleaving neurotransmitters, proteases, kinases and the like); substrates for enzymes; peptides; cofactors; lectins; sugars; polysaccharides; cells (which can include cell surface antigens); cellular membranes; organelles; etc., as well as other such molecules or other substances which can exist in complexed, covalently bonded crosslinked, etc. form. As used herein, the terms nucleic acid, polynucleotide, polynucleic acid and oligonucleotide are interchangeable. Targets can also be referred to as anti-probes.

As used herein a “detector” is a substance, e.g., a molecule, placed in a detection zone for interacting with a target. The types of potential detector/target or target/detector binding partners include receptor/ligand; ligand/antiligand; nucleic acid (polynucleotide) interactions, including DNA/DNA, DNA/RNA, PNA (peptide nucleic acid)/nucleic acid; enzymes, other catalysts, or other substances, with substrates, small molecules or effector molecules; etc. Examples of detectors that are contemplated by this invention include, but are not limited to, organic and inorganic materials or polymers, including metals, chelating agents or other compounds which interact specifically with metals, plastics, agonists and antagonists for cell membrane receptors, toxins and venoms, viral epitopes, hormones (e.g., opioid pikttides, steroids, etc.), hormone receptors, lipids (including phospholipids), peptides, enzymes (such as proteases or kinases), enzyme substrates, cofactors, drugs, lectins, sugars, nucleic acids (including oligonucleotides, DNA, RNA, PNA or modified or substituted nucleic acids), oligosaccharides, proteins, aptamers, enzymes, polyclonal and monoclonal antibodies, single chain antibodies, or fragments thereof. Detection polymers can be linear or cyclic. Detectors can distinguish between phosphorylated and non-phosphorylated proteins, either by virtue of differential activity or differential binding. Detectors such as lectins can distinguish among glycosylated proteins. As used herein, the terms nucleic acid, polynucleotide, polynucleic acid and oligonucleotide are interchangeable. Any of the substances described above as “detectors” can also serve as “targets,” and vice-versa.

The term “detection” includes both quantitative and qualitative analysis of a target.

Any compatible substrate or surface can be used for forming a device according to this invention. The surface (usually a solid) can be any of a variety of organic or inorganic materials or combinations thereof, including, merely by way of example, plastics such as polycarbonate, polypropylene and polystyrene; ceramic; silicon; (fused) silica, quartz or glass, which can have the thickness of, for example, a glass microscope slide or a glass cover slip; paper, such as filter paper; diazotized cellulose; nitrocellulose filters; nylon membrane; or polyacrylamide or other type of gel pad, e.g., an aeropad or aerobead, made of an aerogel, which is, e.g., a highly porous solid, including a film, which is prepared by drying of a wet gel by any of a variety of routine, conventional methods. Substrates that are transparent to light are useful when the method of performing an assay involves optical detection. In a preferred embodiment, the surface is the plastic surface of a multiwell, e.g., tissue culture dish, for example a 24-, 96-, 256-, 384-, 864- or 1536-well plate (e.g., a modified plate such as a Coming Costar DNA Bind plate).

Detectors can be associated, e.g., bound, directly with a surface, or can be associated with one type of surface, e.g., glass, which in turn is placed in contact with a second surface, e.g., within a plastic “well” in a microtiter dish. The shape of the surface is not critical. It can, for example, be a flat surface such as a square, rectangle, or circle; a curved surface; or a three dimensional surface such as a bead, particle, strand, precipitate, tube, sphere; etc. Examples include plates, sheets, films, and threads. Preferred, but not required shapes are those with flat planar surfaces, such as a microplate, that can be handled by an automated diagnostic system.

In a preferred embodiment, the detection zones can be wells of a multiwell dish, for example a 24-, 96-, 256-, 384-, 864- or 1536-well plate. Alternatively, a surface such as a glass surface can be etched out to have, for example, 864 or 1536 discrete, shallow wells. Alternatively, a surface can comprise regions with no separations or wells, for example a flat surface, e.g. piece of plastic, glass or paper, and individual regions can further be defined by overlaying a structure (e.g., a piece of plastic or glass) which delineates the separate regions.

Zones within or on a surface can also be defined by modification of the surface itself. For example, a plastic surface can comprise portions made of modified or derivatized plastic, which can serve, e.g., as sites for the addition of specific types of detectors (e.g., PEG can be attached to a polystyrene surface and then derivatized with carboxyl or amino groups, double bonds, aldehydes, and the like). Alternatively, a plastic surface can comprise molded structures such as protrusions or bumps, which can serve as platforms for the addition of anchors. In another embodiment can be gel pads, e.g., polyacrylamide gel pads or aeropads, which are arrayed in a desired pattern on a surface such as, e.g., glass, or are sandwiched between two surfaces, such as, e.g., glass and a quartz plate. Anchors, linkers, etc. can be immobilized on the surface of such pads, or can be imbedded within them. A variety of other arrangements of gel pads on surfaces will be evident to one of skill in the art, and can be produced by routine, conventional methods. The relative orientation of the detection zones can take any of a variety of forms including, but not limited to, parallel or perpendicular arrays within a square or rectangular or other surface, radially extending arrays within a circular or other surface, or linear arrays, etc.

The size and physical spacing of the detection zones are not limiting. Typical detectors are of an area of about 1 to about 700 mm², preferably 1 to about 40 mm², and are spaced about 0.5 to about 5 mm apart, and are routinely selected depending on the areas involved. In a preferred embodiment, the zones are spaced approximately 5 mm apart. For example, each zone can comprise a rectangular grid, with, for example, 8 rows and 6 columns; of roughly circular spots of zones which are about 75 to about 500, and typically about 100 micrometers in diameter, and about 100 to about 1000, and typically about 500 micrometers apart; such a zone would cover about a 20 millimeter square area. Larger and smaller zone areas and spacings are included.

The zones can be further subdivided such that the different detection spots within a zone are physically separated from neighboring seats by means, e.g., of an indentation or dimple.

The detection spots are suitable for providing a detectible indication in the presence of a specific target. The detectible indication of the presence of a target can be any reporter molecule, also referred to as signal generators, used with arrays. Examples of reporter molecules include but are not limited to, dyes, chemiluminescent compounds, enzymes, fluorescent compounds, metal complexes, magnetic particles, biotin, haptens, radio frequency transmitters, and radioluminescent compounds.

Preferred signal generators are fluorophores. Fluorophores that can be used include those described in U.S. Pat. No. 6,351,712, which is incorporated herein by reference. Examples of fluorophores that can be used include rhodamine 110, rhodal, fluorescein, coumarin, and derivatives of rhodamine 110, rhodal, or fluorescein. Cyanine dyes such as Cy2, Cy3, Cy5, Cy 5.5, and Cy7. Other suitable fluorophores are phycobiliproteins, such as those available from Martek Biosciences (Columbia, Md.) under the trade name PBXL.

Examples of radioactive signal generators that can be used in the invention include ³²P, ³³P, ³⁵S, ³H, and ¹²⁵I. Chemiluminescent signal generators that can be used in the invention include acridinium esters, ruthenium complexes, metal complexes, and oxalate ester—peroxide combination. Enzyme labels that can be used in the invention include alkaline phosphatase, horseradish peroxidase, and beta-galactosidase. Examples of other signal generators that can be used in the invention include thiopeptolides, anthroquinone dyes, nitro blue tetrazolium, and ortho-nitrophenol β-D-galacto-piranoside (ONPG).

The presence of the fluorophore gives a detectible indication when the fluorophore, is subject to exciting light such as from a laser. The presence of a fluorophore can be detected with a detection device such as a CCD (Charge Coupled Device) camera system of the type provided by Spectra Source, Inc. under the name Teleris 2. Other detection devices that can be used are a scanning confocal laser microscope, photomultiplier tubes, photodiode arrays, charge injection devices, and CMOS image sensors).

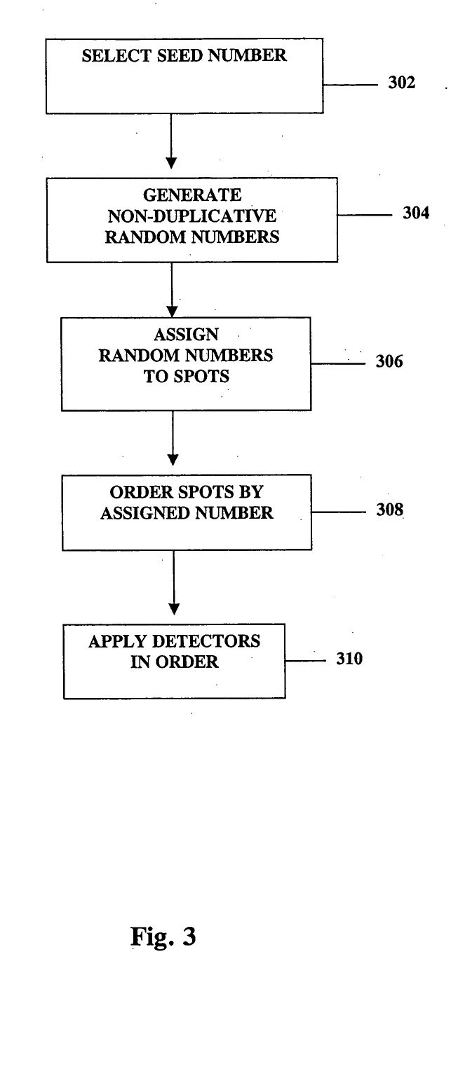

FIG. 3 is a flow chart showing how a device of the type of FIG. 2 can be made with a randomized predetermined pattern for the detector spots. It involves the steps of selecting a seed number 302, and then generating non-duplicative random numbers 304 with a random number generating algorithm. The random numbers are generated so there is one non-duplicative number for each of the detection spots except for registration spots 12 and 112. Each detection region preferably contains one or more registration spots to enhance array location and image analysis. These registration spots are used typically for spatial rather than quantitative intensity information, and so their function is not impaired by having them adjacent to an edge.

The next step 306 is to assign random-numbers to the spots. The spots are then ordered in step 308 by their respective assigned number and then the detectors are applied to the device in step 310 in the order resulting from step 308.

Tables 1 and 2 exemplify how a detection zone is prepared according to this method. In this example, there are two wells, well 1, as represented in Table 1 and well 2, as represented in Table 2, each containing sixteen detection spots, three each of five different detectors, and one non-randomized spot that is used for registration. Using the method shown in FIG. 3, each spot is given a random number. In this example, thirty non-duplicative random numbers are generated and the spots are assigned the random numbers in the layout order, with the spots in well 1 being assigned the first 15 random numbers generated and the spots in well 2 being assigned the next 15 random numbers generated.

The spots are ordered based on the random number. For example, in well 1, spot 7 has the lowest random number, and is printed first, and spot 14 has the highest random number and is printed last. Similarly, in well 2, spot 10 has the lowest random number and is printed first, and spot 9 has the highest random number and is printed sixth. Also, spot 6 is not randomized, being the registration spot, and is always printed sixth.

TABLE 1 (WELL 1)

| | Applied Random | | |
|---|---|---|---|
| Layout | Number | Order Printed | Detector |
| 1 | 15 | 3 | A |
| 2 | 183 | 14 | E |
| 3 | 5 | 2 | A |
| 4 | 27 | 5 | B |
| 5 | 48 | 11 | D |
| 6 | Not Randomized | 6 | Registration |
| 7 | 2 | 1 | A |
| 8 | 45 | 10 | C |
| 9 | 31 | 8 | C |
| 10 | 69 | 12 | D |
| 11 | 74 | 13 | D |
| 12 | 16 | 4 | B |
| 13 | 103 | 15 | E |
| 14 | 153 | 16 | E |
| 15 | 28 | 7 | B |
| 16 | 42 | 9 | C |

TABLE 2
(Well 2)

| | Applied Random | | |
|---|---|---|---|
| Layout | Number | Order Printed | Detector |
| 1 | 103 | 2 | A |
| 2 | 473 | 15 | E |
| 3 | 215 | 8 | C |
| 4 | 145 | 4 | B |
| 5 | 311 | 11 | D |
| 6 | Not Randomized | 6 | Registration |
| 7 | 437 | 14 | E |
| 8 | 199 | 7 | B |
| 9 | 475 | 16 | E |
| 10 | 75 | 1 | A |
| 11 | 318 | 12 | D |
| 12 | 240 | 9 | C |
| 13 | 117 | 3 | A |
| 14 | 401 | 13 | D |
| 15 | 273 | 10 | C |
| 16 | 155 | 5 | B |

A printer is instructed to print the spots in order, with the first three spots receiving detector A, the next three spots receiving detector B, etc. until the last three spots are printed with detector E. This results in the detector pattern listed in Tables 1 and 2.

The random numbers can be generated with any conventional random number generator, which is typically a pseudo-random number generators. Although algorithms for generating random numbers generators have been developed, the very existence of the algorithm, no matter how sophisticated, means that the next digit can be predicted based on the algorithm, and thus such term “pseudo-random” is applied to such machine-generated strings of digits. Although they are equivalent to random number sequences for most applications, they are not truly random.

Among available random number generators that can be used in the present invention are: ISAAC, URN(Jinf. Compt. Si. 20, pages 56-58 1980) and RSA. If desired, the randomness obtained from the generator can be validated by standard tests.

According to the present invention there are at least four spaced apart detection zones. Typically, there are at least 50 detection zones, each detection zone containing at least six spaced apart detector spots. Typically, there are at least thirty such detection spots in each zone, with at least three different types of detection spots in each zone. Preferably, there are at least ten different detection spots in each zone. For example, the device 100 can have about 96 detection zones, each being a well, with about 42 spots per detection zone, there being about 14 different detection spots in each detection zone. Optionally, there can be 42 different detection spots.

It is preferable, but not required, that the pattern of the detection spots not be duplicated in any of the zones. However, in order to be within the scope of the present invention, it is only necessary that there be at least four detection zones with different patterns. Thus, it is within the scope of the present invention, but certainly not preferred, that for a device having 96 wells, only four of the wells be randomized with the other 92 having the exact same pattern. However, it is much preferred to have all 96 wells with randomized patterns.

By such randomization, edge effects within an array are less likely to systematically bias any single result. This occurs because the same detector is not located at the edge or corner position of each array. Any inter-array edge effects present no longer introduce systematic error but instead appear as a statistically random error. Any statistically random error can be reduced, if needed, but repeating the same analysis on duplicate devices, and. then computing the mean result. Thus, edge effects can have substantially no effect on the accuracy of the device 100.

Detectors can be printed with an ink jet printer, such as a PROSYS™ 4210 system available from Genomic Solutions of Ann Arbor, Mich. Printing techniques utilizing jet printers and piezoelectric microjet printing techniques are described in U.S. Pat. No. 4,877,745, which is incorporated herein by reference. The method of patterning used in the invention can be changed within the scope of the invention, including, but not limited to: thermal jet printing, piezo jet printing, stamping, pin printing, sprays, embossing, and optical microlithography.

The control of the printing and determination of the random numbers can be performed with a computer system.

A feature of the present invention, which can be used with or without the randomization feature, is to provide a code on the device so that the array pattern can be determined by the user. For example, by providing the device the seed number used in the random number generator and from knowledge of the algorithm used, it is possible to determine the pattern of detection spots. This is preferable to another alternative, which is to provide data that duplicates the full map of the array layout.

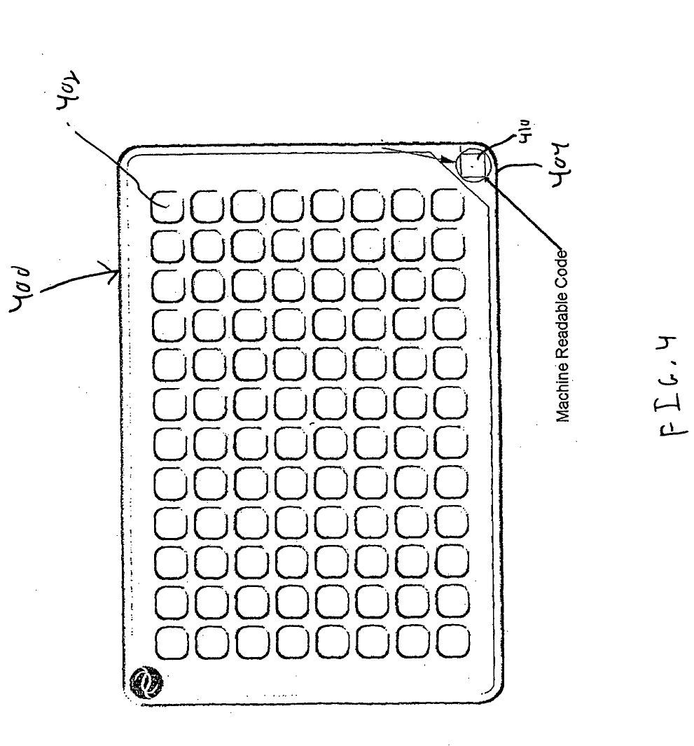

As shown in FIG. 4, a device 400 according to the present invention has 96 detection zones or wells 402 and a code area 404. The code area 404 contains a printed code 410 from which the pattern of the detection spots can be determined. The code can be in the form of a machine-or number-readable bar code or character sequence. For example, machine readable code such as Data Matrix ECC 200 (RBSI CiMatrix of Canton, Mass.) is capable of deploying about 46 ASCII characters of code information on a single array device in a 0.2 inch square area as exemplified in FIG. 4.

To decode the pattern used for a particular array, the code 404 is read into a computer system. The code can be a serial number, or it. can be a date that the device 400 was manufactured. For example, if the device 400 was produced on Aug. 15, 2003, the code could be the sum of the digits of the date, which in this instance is 19(0+8+1+5+2+0+0+3). The pattern in this case was generated using 19 as a seed number in the algorithm, and from knowledge of the algorithm and the seed number, it is possible to have a computer system determine the type of detector used in each detection spot in the array.

If a bar code is used, it can be placed as shown in FIG. 4, or can be placed on a side of the array for reading by a bar code reader. In a preferred version of the invention, instead of using a bar code, a two-dimensional data array grid is used. The grid can have a series of data spots, each being on or off, depending on whether there is presence or absence of an indicator. The indicator is chosen so that it is readable at the same time the detection spots are read by a device such as a CCD device. This version of the invention has an advantage over a bar code system in that only one detection device is required.

With this system, there is no need to retain a full map of the array in computer memory.

The present invention has significant advantages. It helps control the edge artifacts that appear in the detection data. In addition to reducing errors from edge effects, the invention can also be useful for removing and reducing systematic errors resulting from uneven illumination, array patterning errors, substrate irregularity, optical aberration in imaging systems, or any source of undesirable variation relating to physical array layout.

Another benefit of the invention relates to security. Unless a person knows how to read the code provided with the device, and has knowledge of the algorithm used to generate the array pattern, the array device is not useful. Thus, unauthorized use of array devices is avoided.

If a high degree of security is desired, it is possible to use an encryption key during preparation of the device which permits only a particular key to function during reading of the code. This can be, accomplished by using public key encryption methods to assign a “public key” to the array device and distribute a single algorithm for reading. Knowledge of the algorithm and public key are not sufficient to resolve the analytical information. Rather, a “private key” (or keys) assigned only to authorized analysts or sites is required to associate detection spots with the particular detectors actually at the spots. For additional security, the ability to read plates or devices can be revoked by revocation of the private “key.”

Thus, the present invention reduces or eliminates types of systematic errors associated with array devices, automates the layout of array devices in a statistically rigorous fashion, permits greatly enhanced security of array content, and facilitates software control of access to meaningful analytical information by denying unauthorized use of array data.

The present invention is adaptable to those applications that include a patterned immobilization of biological or chemical detectors on a solid substrate for further reaction, binding, complexing, or sensing of biological or chemical materials. Examples of systems conventionally adaptable to the present invention include various array based clinical assay systerns. The present invention can be used in clinical analysis and research for identifying drugs of abuse infectious disease, and blood analytes, drug discovery, structure-functional research, forensics, environmental testing, chemical exposure dosimetry, cell-based assays, etc.

In use of a device according to the present invention, spots can be brought into contact with a complex sample mixture such that tens or hundreds of targets can be analyzed quantitatively or qualitatively simultaneously. Alternatively, other microwell plates can be fabricated to meet the needs of the assay for reagent reservoirs.

Although the present invention has been described in considerable detail with reference to certain preferred versions thereof, other versions are possible. Therefore, the spirit and scope of the appended claims should not be limited to the description of the preferred versions contained herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” for “step” clause as specified in 35 U.S.C. § 112.

1. A device for detection of targets comprising an array of at least 4 spaced apart detection zones, each detection zone containing at least 6 spaced apart detection spots in a pre-determined pattern, the detection spots being suitable for providing a detectible indication of the presence of a specific target, there being at least 3 different detection spots in each detection zone,
wherein no two detection zones have the same pre-determined pattern.

2. The device of claim 1 wherein at least some of the detection zones are wells.

3. A device for detection of targets comprising an array of spaced apart detection zones, at least 4 of the detection zones being randomized, each randomized detection zone containing at least 6 spaced apart detection spots in a pre-determined pattern, there being at least 3 different detection spots in each randomized detection zone,
wherein the pre-determined patterns in the randomized detection zones are randomized.

4. The device of claim 3 wherein the detection zones have edges, and the pre-determined patterns are randomized so that edge effects have substantially no effect on the accuracy of the device.

5. The device of claim 3 wherein at least some of the detection zones have at least one spot that is not randomized.

6. A device for detection of targets comprising an array of at least 4 spaced apart detection zones, each detection zone containing at least 6 spaced apart detection spots in a pre-determined pattern, the detection spots being suitable for providing a detectible indication of the presence of a specific target, there being at least 3 different detection spots in each detection zone,
wherein the pre-determined patterns are determined with a random number generator.

7. A device for detection of targets comprising:
a) an array of at least 4 spaced apart detection zones, each detection zone containing at least 6 spaced apart detection spots in a pre-determined pattern, the detection spots being suitable for providing a detectible indication of the presence of a specific target, there being at least 3 different detection spots in each detection zone; and
b) a readable code that allows a detector to determine the pre-determined patterns.

8. The device of claim 7 wherein the code is machine readable.

9. The device of claim 8 wherein the code and the detectible indicator can be read with the same detection device.

10. The device of claim 7 wherein the code is encrypted.

11. The device of claim 7 wherein no two detection zones have the same pre-determined pattern.

12. The device of claim 7 wherein the pre-determined patterns are randomized.

13. The device of claim 12 wherein the detection zones have edges, and the pre-determined patterns are randomized so that edge effects have substantially no effect on the accuracy of the device.

14. The device of claim 7 wherein the pre-determined patterns are determined with a random number generator.

15. A method for detecting targets in a sample comprising the step of applying the sample to the device of any one of claims 1, 3, 6 and 7.

16. A method for detecting targets in a sample comprising the steps of:
a) selecting the device of claim 7;
b) applying the sample to the selected device so that the targets cause at least some of the detections spots to provide the detectible indication;
c) reading the readable code to determine the pre-determined patterns; and
d) detecting the detectible indication and identifying targets present in the sample based on the determined pre-determined patterns.

17. The method of claim 16 wherein the code is machine readable, and the steps of reading the readable code, and the steps of reading the readable code and detecting are performed with the same reading device.

18. A method of forming a detection array comprising at least 4 spaced apart detection zones, each detection zone containing at least 6 spaced apart detection spots, the detection spots being capable of providing a detectible indication of the presence of a specific target, there being at least 3 different detection spots in each detection zone, the method comprising the steps of:
a) determining a randomized pattern for the detection spots; and
b) applying the detection spots to a substrate in the determined randomized pattern;

19. The method of claim 18 comprising the additional step of providing a machine readable code that allows a detector to determine the randomized pattern.

20. The method of claim 19 in which the machine readable code is placed on the substrate.

21. The method of claim 19 in which the machine readable code is encrypted.

22. The method of claim 19 in which the step of determining a randomized pattern comprises determining the pattern with a random number generator algorithm.

23. The invention of claim 1 wherein the array comprises at least 50 detection zones.

24. The invention of claim 1 wherein the array comprises at least 30 spots per zone.

25. The invention of claim 1 wherein there are at least 10 different detection spots in each detection zone.

26. The invention of claim 1 wherein the array comprises about 96 detection zones, the detection zones are wells, there are about 42 spots per detection zone, and there are about 14 different detection spots in each detection zone.

27. The invention of claim 3 wherein the array comprises at least one detection zone that is not a randomized detection zone.

28. In a microarray comprising a plurality of detection zones having detection spots in a selected pattern, the improvement comprising the selected patterns being randomized.
